(19) United States
(12) Patent Application Publication
(10) Pub. No.: US 2022/0080670 A1
(43) Pub. Date: Mar. 17, 2022

(54) COLORED OBJECT GENERATION

(71) Applicant: Hewlett-Packard Development Company, L.P., Spring, TX (US)

(72) Inventors: Pol Fornos Martinez, Sant Cugat del Valles (ES); Adam Franks, Grenoble (FR); Maria de las Mercedes Blanco Rollan, Sant Cugat del Valles (ES); Ismael Fernandez Aymerich, Sant Cugat del Valles (ES)

(73) Assignee: Hewlett-Packard Development Company, L.P., Spring, TX (US)

(21) Appl. No.: 17/418,182

(22) PCT Filed: Apr. 30, 2019
(86) PCT No.: PCT/US2019/029995

§ 371 Date: Jun. 24, 2021

(51) Int. Cl. B29C 64/393; B29C 64/165; B33Y 10/00; B33Y 30/00; B33Y 50/02

(52) U.S. Cl. CPC B29C 64/393; B29C 64/165; B33Y 50/02; B33Y 30/00; B33Y 10/00

(57) ABSTRACT

An example method of generating three-dimensional objects is disclosed. Object generation instructions to generate the object may be determined by defining a shell region of a layer of build material corresponding to the first portion of the object having a first color, and defining a fusing agent region on a layer of build material adjacent to the shell region on which fusing agent of a second color is to be applied and specifying an amount of colorant to be applied to the shell region wherein the object generation instructions specify application of fusing agent and colorant such that, when the layer of build material is heated using a heat source, the fusing agent region of the build material melts due to energy absorbed from the heat source and the build material of the shell region melts due, at least in part, to energy transfer from the fusing agent region.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected sub-regions. In other techniques, chemical solidification methods may be used.

### BRIEF DESCRIPTION OF THE DRAWINGS

Non-limiting examples will now be described with reference to the accompanying drawings, in which:

FIG. 1 is a flowchart of an example method of generating a three-dimensional object in a 3D printing system;

FIG. 2 shows a schematic representation of part of a method of generating a three-dimensional object in a 3D printing system according to an example;

FIG. 3 shows another schematic representation of part of a method of generating a three-dimensional object in a 3D printing system according to an example;

FIG. 4 shows a schematic representation of an example apparatus for processing data for additive manufacturing;

FIG. 5 shows a schematic representation of an example apparatus for additive manufacturing; and

FIG. 6 shows a schematic representation of a machine-readable medium in association with a processor according to an example.

### DETAILED DESCRIPTION

Additive manufacturing techniques may generate a three-dimensional object through the solidification of a build material. In some examples, the build material is a powder-like granular material, which may for example be a plastic or ceramic powder and the properties of generated objects may depend on the type of build material and the type of solidification mechanism used. Build material may be deposited, for example on a print bed and processed layer by layer, for example within a fabrication chamber. According to one example, a suitable build material may be PA12 build material commercially known as V1 R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto regions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies upon cooling to form a slice of the three-dimensional object in accordance with the pattern. In this way, adding fusing agent to areas of the build material may change the absorptivity of those areas of the build material. In other examples, coalescence may be achieved in some other manner.

In an example, a suitable fusing agent may be an ink-type formulation comprising carbon black, such as, for example, the fusing agent formulation commercially known as V1Q60A “HP fusing agent” available from HP Inc. In some examples, a fusing agent may comprise at least one of an infra-red light absorber, a near infra-red light absorber, a visible light absorber and a UV light absorber. Examples of print agents comprising visible light enhancers are dye based colored ink and pigment based colored ink, such as inks commercially known as CE039A and CE042A available from HP Inc. Adding a colored fusing agent (for example a black fusing agent) may change the color of the build material to which it is applied. For example, adding a black fusing agent to a white build material may result in the corresponding parts of the three-dimensional object to be generated being dark (e.g. black) in appearance. In some examples, a suitable fusing agent may be a low-tint fusing agent. Low-tint fusing agents which have a relatively high absorptance (for example comprising a Caesium Tungsten Bronze, or a Caesium Tungsten Oxide compositions) and which are lighter in color than a carbon black based print agent may be used as fusing agents

In addition to a fusing agent, in some examples, a coalescence modifier agent may be used which acts to modify the effects of a fusing agent for example by modifying coalescence or to assist in producing a particular finish or appearance to an object, and such agents may therefore be termed detailing agents. Detailing agents may be applied to produce a cooling effect. In some examples, detailing agent may be used near edge surfaces of an object being printed. According to one example, a suitable detailing agent may be a formulation commercially known as V1Q61A “HP detailing agent” available from HP Inc. A coloring agent, for example comprising a dye or colorant, may in some examples be used as a fusing agent or a coalescence modifier agent to provide a particular color for the object.

As noted above, additive manufacturing systems may generate objects based on structural design data. This may involve a designer generating a three-dimensional model of an object to be generated, for example using a computer aided design (CAD) application. The model may define the solid portions of the object, and, in some examples, properties such as color, strength, density and the like. To generate a three-dimensional object from the model using an additive manufacturing system, the model data may, in some examples, be processed to generate slices of parallel planes of the model. Each slice may define a region of a respective layer of build material that is to be solidified or caused to coalesce by the additive manufacturing system.

When heat is applied to an area of a build material that is treated with fusing agent, heat from the area of build material may bleed into surrounding areas (e.g. in the same layer or between layers) and cause adjacent areas of build material (which may not be intended to form a portion of the object being generated) to at least partially fuse and become a portion of the generated object. This may lead to objects having dimensions larger than were defined in an object model describing the object to be generated. To improve dimensional accuracy, a detailing agent may be applied immediately adjacent to areas of build material on which fusing agent is applied to reduce, or in some examples prevent, this thermal bleed from these areas of build material. In this way, a detailing agent may be applied to define the surface geometry of the object being generated.

Some examples herein relate to controlling this thermal bleed effect by leaving a shell region of build material adjacent to a core region of build material where fusing agent has been applied, wherein build material in the shell region is to fuse to the core region due to thermal bleed from the core region.

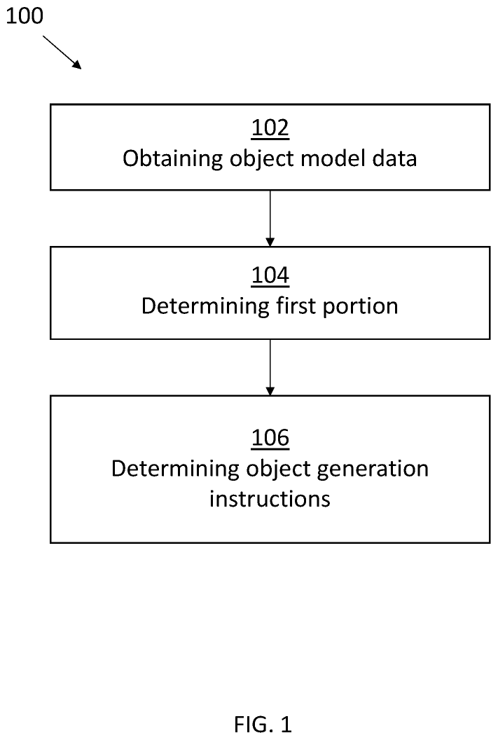

FIG. 1 is an example method, 100 which may be a method of generating a three-dimensional object in a 3D printing system using a fusing agent and build material comprising, at block 102, obtaining (e.g. by a processor) object model data describing an object to be generated by additive manufacturing.

The object model data may comprise data representing at least a portion of an object to be generated by an additive manufacturing apparatus by fusing (e.g. thermal fusing through application of energy) or solidifying a build material. The object model data may, for example, comprise a Computer Aided Design (CAD) generated model, and/or may, for example, be represented in a suitable file format, such as in a STereoLithographic (STL) data file. In some examples, the object model data may be received over a network, or received from a local memory or the like. In some examples, the object model data may define the shape of the portion of an object, i.e. its geometry. In some examples, the data may additionally define an appearance property, for example at least one intended color, pattern, translucency, gloss or the like. In some examples the data may define at least one mechanical property, for example strength, density, resilience or the like. In some examples, the data may define at least one functional property, for example, conductivity in at least one object portion. Such properties may be associated with regions of the object, for example a color may be defined at an object surface.

In some examples, the object may be defined in terms of sub-volumes, each of which represents a region of the object which is individually addressable in object generation. In some examples herein, the sub-volumes may be referred to as voxels, i.e. three-dimensional pixels, wherein each voxel occupies or represents a discrete volume. In some examples of additive manufacturing, three-dimensional space may be characterized in terms of such voxels. In some examples, the voxels may be determined bearing in mind the print resolution of an object generation apparatus, such that each voxel represents a region which may be uniquely addressed when applying print agents, and therefore the properties of one voxel may vary from those of neighbouring voxel(s). In other words, a voxel may correspond to a volume which can be individually addressed by an object generation apparatus (which may be a particular object generation apparatus, or a class of object generation apparatus, or the like) such that the properties thereof can be determined at least substantially independently of the properties of other voxels. For example, the ‘height’ of a voxel may correspond to the height of a layer of build material. In some examples, the resolution of an object generation apparatus may exceed the resolution of a voxel. In general, the voxels of an object model may each have the same shape (for example, cuboid or tetrahedral), but they may in principle differ in shape. In some examples, voxels are cuboids having the height of a layer of build material and a cubic face having an area of between 20×20 μm and 60×60 μm on the surface onto which print agents are to be deposited. In some examples, in processing object model data representing an object, each voxel may be associated with properties, and/or object generation instructions, which apply to the voxel as a whole.

In other examples, the object may be described in some other way, for example using a vector or polygon mesh-based model. In some such examples, a voxel model may be derived from another model type.

In some examples, the method of FIG. 1 may be carried out on a slice-by-slice basis. In some examples, each slice may correspond to a layer of an object to be generated in a layer-by-layer additive manufacturing process. In some examples, such slices may be slices of a virtual build volume modelling an intended ‘real’ build volume, and may comprise slices taken from more than one object model. In some examples, the slices may be one voxel thick.

Block 104 of method 100 comprises determining a first portion of the object to be generated to have a first color. In some examples the first color may be represented by a color value or a set of color values, such as in a RBG or CMYK color format.

Block 106 comprises determining object generation instructions to generate the object by defining a shell region of a layer of build material that is to correspond to the first portion of the object, and a fusing agent region on a layer of build material adjacent to the shell region on which fusing agent of a second color is to be applied; and specifying an amount of colorant to be applied to the shell region. In some examples, the shell region and the fusing agent region may be part of different adjacent layers of build material. In other words, the fusing agent region may be a part of one or multiple layers of build material with the shell region being part of different layer(s), or part of one of the layers that comprises the fusing agent region. It will therefore be appreciated that the fusing agent region and shell region may, in some examples, be part of the same layer of build material. In other examples the shell region may be provided in a separate layer to the fusing agent region.

In some examples the colorant may comprise a single type of colorant to be applied to the shell region to provide the first color to the object once generated. In some examples a plurality of different types of colorant may be applied to the shell region in order to provide the first color. In some examples a colorant or a plurality of colorants may be applied to the shell region in a halftone pattern to provide a surface appearance having the first color when viewed from a distance. In some examples, between 1 and 50 picoliters of a colorant may be applied to the shell region per voxel location of build material for a voxel having a height of one layer of build material and a surface area for receiving print agent of between 20×20 μm and 60×60 μm, for example, 42×42 μm. The resolution of the printer, in some examples may be 600 dpi. In some examples, between 1 and 50 picoliters of each of a plurality of colorants may be applied to the shell region per voxel of build material. The specific amount of colorant to be applied to the shell region may depend on the particular color of the colorant (e.g. less colorant may be needed for colorants having a darker color) and the type of build material used.

In some examples, determining object generation instructions may comprise applying halftoning to voxel locations associated with object generation parameters to determine object generation or print instructions for the layer. As will be familiar to the skilled person, halftoning can result in the selection of a particular print agent in a particular location. For example, an object generation parameter may specify an area coverage or contone level for a print agent. A halftoning screen or algorithm may be used to make selections of locations and amounts of print agents (i.e. by varying drop spacing or drop size of print agent) to be placed to produce an intended result (which may be fusion of build material in a simple example), for example based on the area coverage. While halftoning is used in this example, in other examples, other techniques may be used.

The object generation instructions determined in block 106 are to specify the application of fusing agent and colorant such that, when the layer of build material is heated using a heat source, the fusing agent region of the build material melts due to energy absorbed from the heat source and the build material of the shell region melts due, at least in part, to energy transfer from the fusing agent region.

In examples where the object model data describes the object in terms of voxels, each voxel representing an addressable region of a layer of build material used to generate the object, the method may comprise calculating a thermal property for an addressable region such as heat capacity, thermal conductivity, thermal diffusivity, specific heat, melting point, and/or thermal expansion coefficient. In some examples a heat prediction model may be used to determine that the fusing agent and colorant are applied such that the layer of build material is heated using a heat source, the build material to which fusing agent is applied melts due to energy absorbed from the heat source and the build material of the shell region melts due, at least in part, to energy transfer from the portion of the layer to which fusing agent is applied. For example, layer may be irradiated with an intensity such that, in the absence of the additional heat provided by the fusing agent region, the shell region would not melt (or at least not within a predetermined timeframe for processing a layer in additive manufacturing, the timeframe being sufficient to cause melting in the fusing agent region).

The object generation instructions generated by method 100 enable generation of a 3D printed part with a colored surface region, without requiring the use of a colourless or mainly colourless fusing agent, also referred to herein as a low-tint fusing agent. In other words, using method 100 colored portions can be produced on a printer that only uses a black fusing agent for fusing. Furthermore method 100 may also enable a dark or black fusing agent to be used for the core region, while giving the part an appearance of a different color due to the shell region. In comparison with parts that are colored with a desired surface color throughout the part, the method of FIG. 1 may result in parts having higher mechanical properties at the core, due to the being able to use a dark fusing agent for the core which results in the centre of the part reaching higher temperatures and therefore producing better coalescence. Providing a shell region around the core region that is to solidify by thermal bleed to form the edges of the part may also reduce thermal shock, which can cause surface effect defects, between the edges of the part and unfused build material surrounding the part on the print bed.

In other words, the method of FIG. 1 utilises thermal bleed when generating a colored object. The transfer of heat from a core portion, which may for example be formed of an inexpensive fusing agent, or a fusing agent with good absorbance but which may not be an intended color (for example, a ‘carbon black’ fusing agent, may assist in melting the build material in a colored shell region. This may reduce the amounts of low-tint fusing agents, which may be more expensive, specified while still resulting fully melted build material (which in turn results in an increase in object strength), and/or may increase an available color gamut.

In some examples, determining object generation instructions 106 comprises defining a band or region of detailing agent on build material immediately adjacent to the shell region (on the same layer of build material or on another layer of build material) to define an outer limit of the shell region and therefore a boundary of the first portion of the object. That is, detailing agent may be applied such that the shell region is defined between a core fusing agent region and a detailing agent band. Applying detailing agent in this way may help to stop any further build material fusing to the object during generation to define an edge of the surface of the object more cleanly.

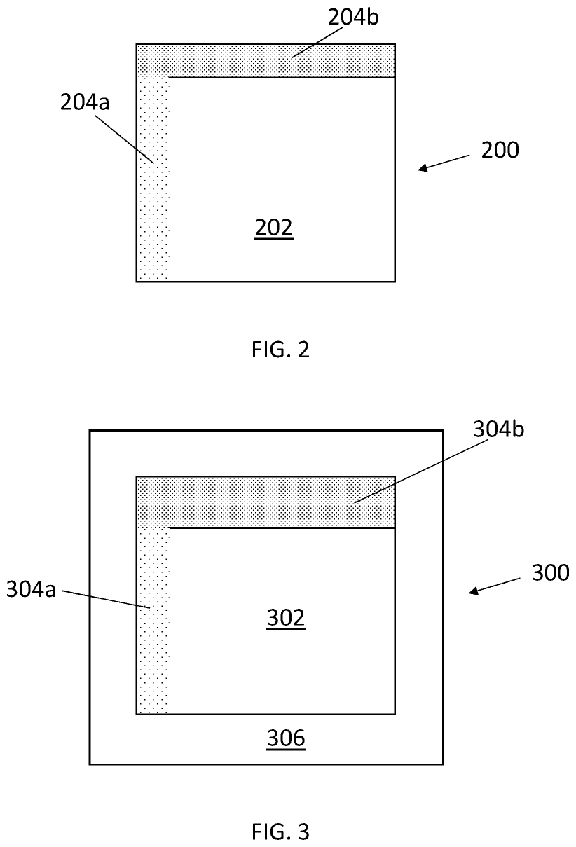

FIG. 2 shows an example of a representation of a slice or layer of build material 200 to which print agent is applied to generate an object, for example as defined by print data generated from the object model that may be obtained in block 102 of method 100. The build material layer 200 contains a portion 202 that comprises a first region or ‘core’ portion of the object. In the first region, sufficient fusing agent will be applied to cause build material in this portion to fuse under direct heat applied to this area by a heater (e.g. a heat lamp) of an additive manufacturing apparatus. For example, fusing agent may be applied with a density such that approximately 10 to 30 picoliters of fusing agent is be applied per voxel location on average, for an example voxel having a height of one layer of build material and a surface area for receiving print agent of between 20×20 μm and 60×60 μm, for example 42×42 μm. The resolution of the printer, in some examples may be 600 dpi. The core portion may have a color defined by the fusing agent when combined with build material. In some examples, the color may be defined by the fusing agent, due to the fusing agent having a dark color (e.g. black) and the build material having a light color (e.g. white).

Build material layer 200 further comprises a shell region 204 to which colorant is to be applied according to print instructions generated from the object model to provide a color defined by the object model. Build material in the shell region 204 does not contain sufficient fusing agent to cause the build material in that region to fuse under direct heat from a heater of the additive manufacturing apparatus. However, additional heat conducted or diffused into this area from the core portion 202 (i.e. due to thermal bleed) will cause build material in the shell region to melt and fuse onto the core portion to form an outer shell or surface layer. In some examples, the thickness of the shell region may be between 20 μm to 1 mm. Different colorants or combinations of colorants may be applied to different parts of a shell region or to different shell regions to provide a plurality of different colors on different portions of a generated 3D object. For example, a first colorant, which may be a single colorant, may be applied to a first part of a shell region 204a to provide a first color and a plurality of colorants may be applied to a second part of a shell region 204b to provide a second color. In the example shown in FIG. 2, the core region has a different color (provided by the fusing agent and the build material) from the color provided by a colorant or a plurality of colorants applied to the shell region 204. For example, the color of the core region may have a different hue, tint, shade, tone, saturation, lightness, chroma, intensity, brightness, reflectance, and/or greyscale. In some examples, the fusing agent and the colorant applied to the shell region have different colors.

FIG. 3 shows another example of a representation of a layer of build material to which print agents are applied in accordance with print data generated from an object model that may be obtained in block 102 of method 100. Similarly to FIG. 2, build material layer 300 comprises a core or fusing agent region 302 and a shell region to which colorant is to be applied 304. Build material layer 300 also includes a detailing agent region 306, which represents a band of detailing agent to be applied to build material adjacent to the shell region to inhibit fusing of the build material in detailing agent region 306. In the build material layer 300 the shell region is defined as a space between the fusing agent region and the detailing agent region. That is, the shell region is delineated by the fusing agent region on one side and by the detailing agent region on an opposite side.

In some examples, the dimensions of the shell region may be determined by determining how much build material is need to completely coat the surface of the core portion. In some examples, the shell region may be thinner than this so that some of the color of the underlying core region is visible through the shell region. In build material layer 300, a first portion of the shell region 304a is thinner than a second portion of the shell region 304b and therefore less of the underlying color of the core region will show through to the surface of shell region 304b of the generated object. In this way the color of the 3D generated object can be further controlled.

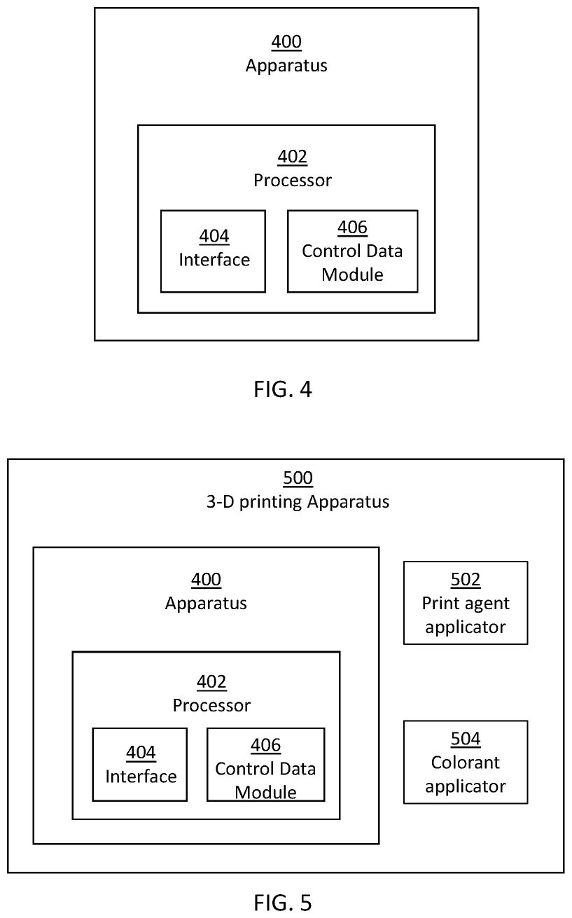

FIG. 4 shows an apparatus 400 which may be an apparatus for processing data for additive manufacturing. The apparatus 400 may be to perform the method 100, or part of the method of FIG. 1. The apparatus 400 comprises a processor 402, wherein the processor 402 comprises an interface 404 to obtain object model data describing at least a portion of an object to be generated by additive manufacturing using a fusing agent and a build material, and to determine a first portion of the object to be generated to have a first color. The processor 402 also comprises a control data module 406 to control a 3D printer to generate the first portion of the object to have a first color by defining a shell region of a layer of build material that is to correspond to the first portion of the object and to which colorant is to be applied, and a fusing agent region on a layer of build material adjacent to the shell region and on which fusing agent of a second color, different from the first color, is to be applied; wherein an amount of colorant to be applied to the shell region and the amount of fusing agent to be applied to the fusing agent region specified by the control data are controlled such that build material in the shell region is to fuse due to thermal energy transfer from the fusing agent region, when heat is applied to the fusing agent region.

FIG. 5 shows an apparatus 500 which may be a 3D printing apparatus for generating an object by additive manufacturing. The apparatus may be suitable to perform the method, or part of the method of FIG. 1. The 3D printing apparatus 500 comprises the apparatus 400 of FIG. 4 as well as a print agent applicator 502 to apply fusing agent to build material in accordance with the control data generated by the control data module 406. The 3D printing apparatus 500 also comprises a colorant applicator 504 to apply colorant to build material in accordance with the control data generated by the control data module 406.

In some examples, the 3D printing apparatus 500 may operate under the control of control data generated based on the print instructions to generate at least one object in a plurality of layers according to the generated control data/print instructions. The 3D printing apparatus 500 may generate an object in layer-wise manner by selectively solidifying portions of layers of build materials. The selective solidification may in some examples be achieved by selectively applying print agents, for example through use of ‘inkjet’ liquid distribution technologies, and applying energy, for example heat, to the layer. The 3D printing apparatus 500 may comprise additional components not shown herein, for example a fabrication chamber, a print bed, print head(s) for distributing print agents, a build material distribution system for providing layers of build material, energy sources such as heat lamps and the like, which are not described in detail herein.

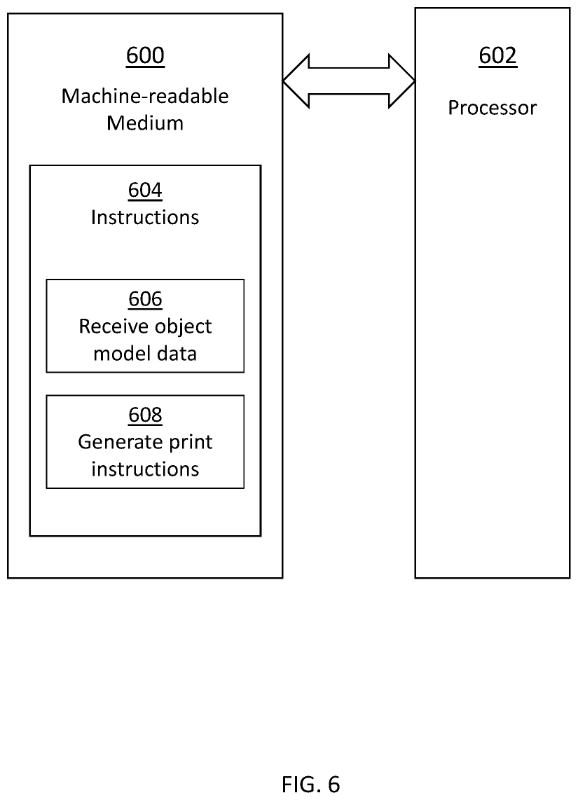

FIG. 6 shows an example tangible machine-readable medium 600 in association with a processor 602. In some examples, the tangible machine-readable medium 600 may form part of an apparatus as described in relation to FIG. 4 or FIG. 5. In some examples, the machine-readable medium and/or the processor 602 may be in communication with an additive manufacturing apparatus, e.g. over a wireless network. The tangible machine-readable medium 600 comprises instructions 604 which, when executed by a processor 602, cause the processor 602 to carry out a plurality of tasks. In some examples, the instructions 604 may cause the processor 602 to carry out methods described herein.

In the example shown in FIG. 6, the machine-readable medium 600 comprises a set of instructions 604 to cause the processor 602 to, at block 606, receive object model data describing an object to be manufactured and an intended surface color of an object portion.

The instructions 604 further comprise, at block 608, instructions to cause the processor 602 to generate print instructions for generating an object using additive manufacturing from the object model data wherein the print instructions specify a first pattern for applying fusing agent to a fusing region of build material to provide a core of the object portion. The generated print instructions are further to specify an amount of colorant to be applied to build material in a shell region adjacent to the fusing region wherein the amount of colorant to be applied to the build material in the shell region is such that: the application of energy which is to fuse the fusing agent region is insufficient to fuse the build material of the shell region alone, but the applied energy and heat transfer from the fusing agent region is sufficient to fuse the shell region by thermal energy transfer (also referred to herein as thermal bleed) from the fusing agent region.

In some examples, the instructions are further to control an additive manufacturing apparatus to apply a band of detailing agent adjacent to the shell region so that the shell region is defined between the detailing agent band and the fusing region.

In some examples, the build material with colorant applied according to the print instructions has a color which corresponds to the intended surface color of the object portion. In some examples, the instructions are to control the additive manufacturing apparatus to apply colorant of a single color to the shell region to provide the intended surface color. In some examples, the instructions are to control the additive manufacturing apparatus to apply a plurality of colorants of different colors to the shell region to provide the intended surface color of the object portion. In some examples, the generated print instructions are to specify that each of the plurality of colorants are applied to the shell region in a halftone pattern to provide the intended surface color of the object portion.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

It shall be understood that some blocks in the flow charts can be realized using machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

What is claimed is:

1. A method of generating a three-dimensional object in a 3D printing system using a fusing agent and build material comprising:
obtaining object model data describing an object to be generated;
determining a first portion of the object to be generated to have a first color;
determining object generation instructions to generate the object by:
defining a shell region of a layer of build material that is to correspond to the first portion of the object, and a fusing agent region on a layer of build material adjacent to the shell region on which fusing agent of a second color is to be applied; and
specifying an amount of colorant to be applied to the shell region;
wherein the object generation instructions specify application of fusing agent and colorant such that, when the layer of build material is heated using a heat source, the fusing agent region of the build material melts due to energy absorbed from the heat source and the build material of the shell region melts due, at least in part, to energy transfer from the fusing agent region.

2. A method according to claim 1, wherein determining the object generation instructions further comprises defining a band of detailing agent on build material immediately adjacent to the shell region to define an outer limit of the shell region and therefore a boundary of the first portion of the object.

3. A method according to claim 1 wherein specifying an amount of colorant to be applied to the shell region comprises specifying an amount of each of a plurality of colorants to apply to the shell region.

4. A method according to claim 3 wherein the plurality of colorants are to be applied to the shell region in a halftone pattern to provide the first color.

5. An apparatus comprising:
a processor, wherein the processor comprises:
an interface to obtain object model data describing at least a portion of an object to be generated by additive manufacturing using a fusing agent and a build material, and to determine a first portion of the object to be generated to have a first color; and
a control data module to generate control data to control a 3D printer to generate the first portion of the object to have a first color by defining a shell region of a layer of build material that is to correspond to the first portion of the object and to which colorant is to be applied, and a fusing agent region on a layer of build material adjacent to the shell region and on which fusing agent of a second color, different from the first color, is to be applied;
wherein an amount of colorant to be applied to the shell region and an amount of fusing agent to be applied to the fusing agent region specified by the control data are controlled such that build material in the shell region is to fuse due, at least in part, to thermal energy transfer from the fusing agent region, when heat is applied to the fusing agent region.

6. An apparatus according to claim 5, wherein the apparatus is a 3D printing apparatus and the apparatus is to generate a 3D object using the control data generated by the control data module.

7. An apparatus according to claim 5 wherein the control data module is to generate control data to define a detailing agent band, to which detailing agent is to be applied, on build material immediately adjacent to the shell region to define an outer limit of the shell region and therefore a boundary of the first portion of the object.

8. An apparatus according to claim 5 wherein applying colorant to the shell region to provide the first color comprises applying a plurality of colorants to the shell region.

9. An apparatus according to claim 5 wherein the object model data describes the object in terms of voxels, each voxel representing an addressable region of a layer of build material used to generate the object.

10. An apparatus according to claim 9 wherein generating control data comprises applying halftoning to voxel locations associated with the first portion of the object.

11. A tangible machine-readable medium comprising a set of instructions which, when executed by a processor cause the processor to control an additive manufacturing apparatus to:
receive object model data describing an object to be manufactured and an intended surface color of an object portion; and
generate print instructions to:
cause fusing agent to be applied to build material in a fusing agent region according to a first pattern to provide a core of the object portion; and
cause colorant to be applied to a shell region adjacent to the fusing agent region, wherein an amount of colorant applied to the build material in the shell region is such that:
application of energy which is sufficient to fuse the fusing agent region is insufficient to fuse the build material of the shell region alone, and
the applied energy and heat transfer from the fusing agent region is sufficient to fuse the shell region by thermal energy transfer from the fusing agent region.

12. A tangible machine-readable medium according to claim 11, wherein the instructions are further to control an additive manufacturing apparatus to apply a band of detailing agent adjacent to the shell region so that the shell region is defined between the detailing agent band and the fusing region.

13. A tangible machine-readable medium according to claim 11 wherein the print instructions are to cause colorant to be applied to the build material to provide the intended surface color of the object portion.

14. A tangible machine-readable medium according to claim 13 wherein the instructions are to control the additive manufacturing apparatus to apply a plurality of colorants to the shell region to provide the intended surface color of the object portion.

15. A tangible machine-readable medium according to claim 14 wherein each of the plurality of colorants are applied to the shell region in a halftone pattern to provide the intended surface color of the object portion.
